(19) United States
(12) Patent Application Publication
(10) Pub. No.: US 2022/0159555 A1
(43) Pub. Date: May 19, 2022

(54) APPARATUS, SYSTEM, AND METHOD OF COMMUNICATING OVER A MILLIMETERWAVE (MMWAVE) CHANNEL BASED ON INFORMATION COMMUNICATED OVER A SUB 10 GIGAHERTZ (GHZ) (SUB-10GHZ) CHANNEL

(71) Applicant: Intel Corporation, Santa Clara, CA (US)

(72) Inventors: Laurent Cariou, Milizac (FR); Cheng Chen, Camas, WA (US); Claudio Da Silva, Portland, OR (US); Po-Kai Huang, San Jose, CA (US); Carlos Cordeiro, Portland, OR (US)

(73) Assignee: Intel Corporation, Santa Clara, CA (US)

(21) Appl. No.: 17/561,760

(22) Filed: Dec. 24, 2021

(51) Int. Cl. H04W 48/12; H04L 5/00; H04W 72/04

(52) U.S. Cl. CPC H04W 48/12; H04L 5/0048; H04L 5/0076; H04L 5/0053; H04W 72/0446

(57) ABSTRACT

For example, an apparatus may be configured to cause an Access Point (AP) Multi-Link Device (MLD) to transmit a first frame from a sub 10 Gigahertz (GHz) (sub-10 GHz) AP of the AP MLD over a sub-10 GHz wireless communication channel, the first frame including a neighbor AP information field, the neighbor AP information field including millimeterWave (mmWave) information corresponding to an mmWave wireless communication station (STA) of the AP MLD, the mmWave information corresponding to the mmWave STA including channel information to indicate an mmWave wireless communication channel of the mmWave STA; and communicate a second frame by the mmWave STA, the second frame communicated with a non-AP MLD over the mmWave wireless communication channel.

### TECHNICAL FIELD

Aspects described herein generally relate to communicating over a millimeterWave (mmWave) wireless communication channel based on mmWave information communicated over a sub 10 Gigahertz (GHz) (sub-10 GHz) wireless communication channel.

### BACKGROUND

A wireless communication network may include multiple wireless communication stations, which may be configured to communicate according to one or more wireless communication protocols. For example, according to some protocols, a network may include one or more Access Point (AP) STAs to communicate with one or more non-AP STAs.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of communicating over a millimeterWave (mmWave) wireless communication channel based on mmWave information communicated over a sub 10 Gigahertz (GHz) (sub-10 GHz) wireless communication channel, in accordance with some demonstrative aspects.

FIG. 5 is a schematic flow-chart illustration of a method of communicating over an mmWave wireless communication channel based on mmWave information communicated over a sub-10 GHz wireless communication channel, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D1.2 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), September 2021)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel BW (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative embodiments are described herein with respect to communication over a channel bandwidth including two or more 2.16 GHz channels, however other embodiments may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel bandwidth of 4.32 GHz, a channel bandwidth of 6.48 GHz, a channel bandwidth of 8.64 GHz, and/or any other additional or alternative channel bandwidth. The EDMG STA may perform other additional or alternative functionality.

In other aspects, the mmWave STA may include any other type of STA and/or may perform other additional or alternative functionality. Other aspects may be implemented by any other apparatus, device and/or station.

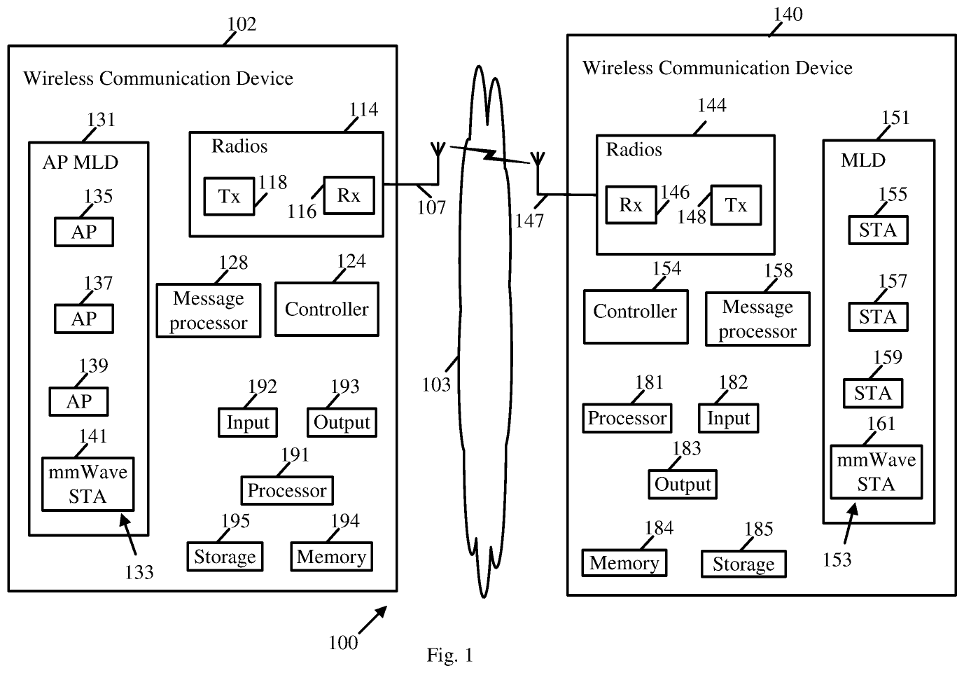

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, a mmWave band, and/or any other band, for example, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102 and/or 140 may include, operate as, perform the role of, and/or perform one or more functionalities of, any other wireless device and/or station, e.g., a WLAN STA, a Wi-Fi STA, and the like.

In some demonstrative aspects, device 102 and/or device 140 may be configured operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, and IEEE 802.11ay Specification and/or any other specification and/or protocol.

In some demonstrative aspects, device 102 and/or device 140 may include, operate as, perform a role of, and/or perform the functionality of, one or more multi-link logical entities, e.g., as described below.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., a mmWave band, for example, a wireless communication band above 45 Ghz, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

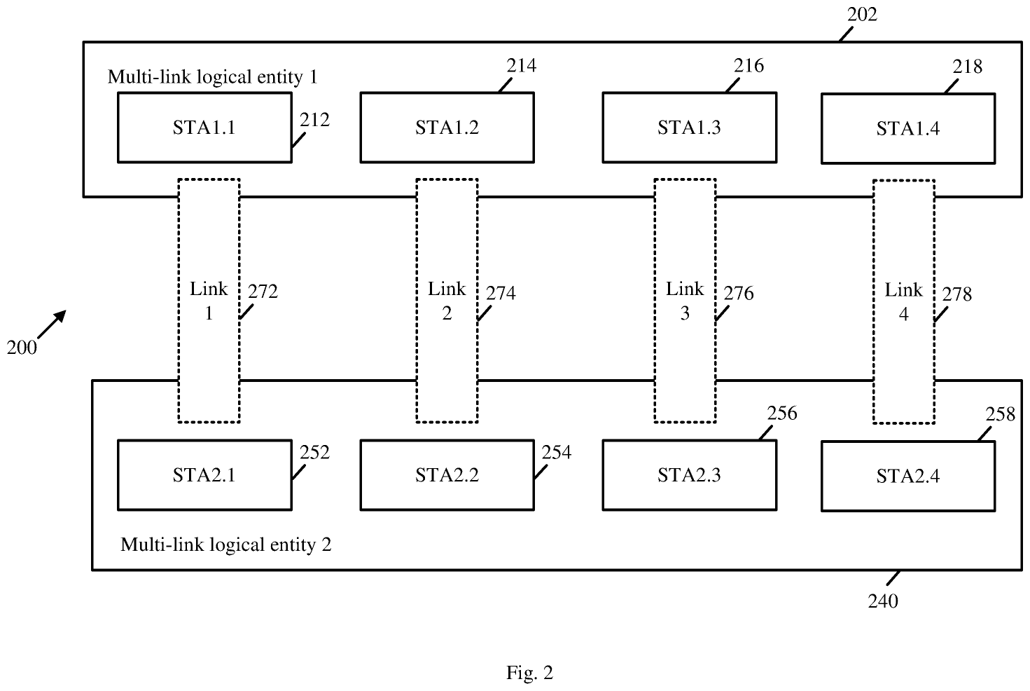

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

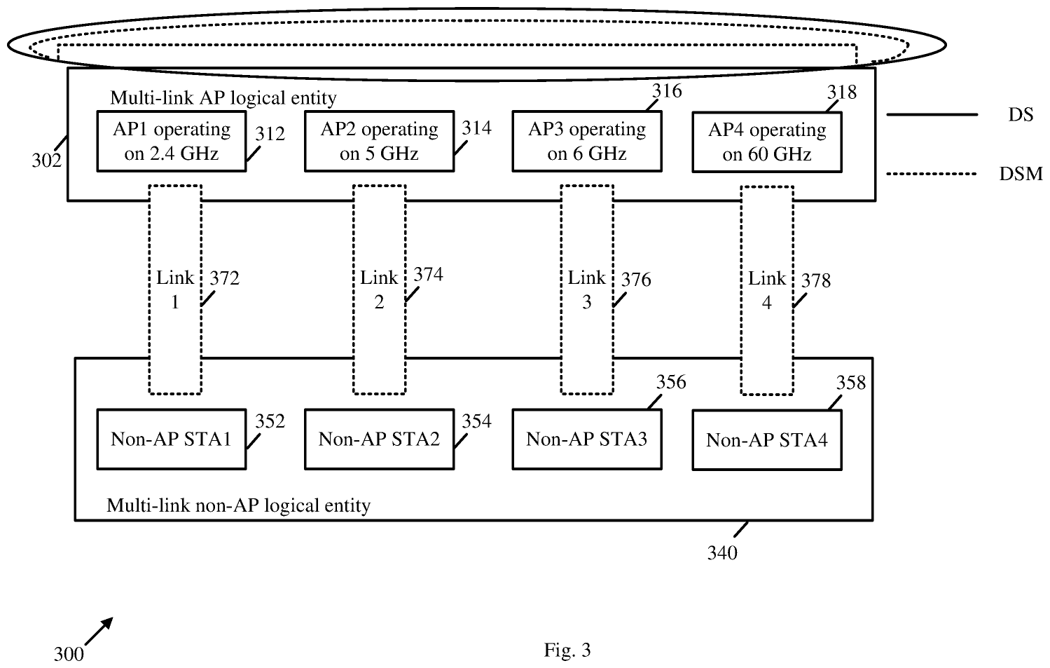

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, devices 102 and/or 140 may be configured to support a technical solution to support communication between mmWave STAs, e.g., mmWave STA 141 and mmWave STA 161, over the mmWave frequency band, e.g., as described below.

In some demonstrative aspects, devices 102 and/or 140 may be configured to support a technical solution to utilize communications over the sub-10 Ghz frequency band, for example, to assist one or more operations to be performed by the mmWave STAs, e.g., mmWave STA 141 and mmWave STA 161, over the mmWave frequency band e.g., as described below.

In some demonstrative aspects, devices 102 and/or 140 may be configured to support a technical solution to support operation over the mmWave frequency band, e.g., over the 60 Ghz frequency band, in a way which may support inclusion of the functionality over the mmWave frequency band, for example, as part of a “mainstream” Wi-Fi solution, e.g., according to a future Wi-Fi 8 technology and/or protocol.

In some demonstrative aspects, for example, in some use cases, implementations, scenarios, and/or deployments, it may be advantageous to implement both sub-10 Ghz communication functionalities and mmWave communication functionalities in a same device, an MLD or any other device, e.g., as described below.

In some demonstrative aspects, device 102 and/or device 140 may be configured to support a co-located technical solution to support both sub-10 Ghz communication functionalities and mmWave communication functionalities in a same device.

For example, device 102 may be configured to support co-located functionality of one or more sub-10 Ghz STAs, e.g., STA 135, STA 137 and/or STA 139, and one or more mmWave STAs, e.g., mmWave STA 141, e.g., as described below.

For example, device 140 may be configured to support co-located functionality of one or more sub-10 Ghz STAs, e.g., STA 155, STA 157 and/or STA 159, and one or more mmWave STAs, e.g., mmWave STA 161, e.g., as described below.

In some demonstrative aspects, for example, in some use cases, implementations, scenarios, and/or deployments, an implementation of both sub-10 Ghz communication functionalities and mmWave communication functionalities in a same device, an MLD or any other device, may be supported by cost reduction, for example, through usage of a hardware architecture, which allows to reuse as much as possible of the same baseband for both the sub-10 GHz radio functionalities as well as for the mmWave radio functionalities.

In some demonstrative aspects, for example, in some use cases, implementations, scenarios, and/or deployments, it may be advantageous to consider an implementation of both sub-10 Ghz communication functionalities and mmWave communication functionalities in a same device, an MLD or any other device, for example, due to less potential for achieving throughput enhancements in the sub-10 Ghz frequency band.

In demonstrative aspects, for example, in some use cases, implementations, scenarios, and/or deployments, it may be advantageous to consider an implementation of both sub-10 Ghz communication functionalities and mmWave communication functionalities in a same device, an MLD or any other device, for example, in view of multi-link framework, e.g., the MLD architecture described above with reference to FIGS. 1-3. For example, multi-link framework may provide a technical solution to make operation on multiple links easier, and may allow to compensate for the fragility of a mmWave link, e.g., a 60 GHz link, for example, through easy fall back to lower band operation, e.g., at the sub-10 GHz frequency band.

In some demonstrative aspects, some PHY characteristics, e.g., main PHY characteristics, for operation at the mmWave frequency band, e.g., the 60 GHz band, may be defined and/or configured, for example, in order to support a technical solution for co-located sub-10 Ghz and mmWave operation, for example, while making as little changes as possible to a baseband design, and/or while reusing most of what was defined in the lower band, e.g., the sub-10 Ghz band, for the mmWave band, e.g., as described below. In one example, functionalities, which are configured for the sub-10 Ghz band may be reused for functionalities in the mmWave band, for example, by upclocking frequencies to adjust to larger bandwidths at the mmWave band, and/or by increasing subcarrier spacing to mitigate phase noise at the mmWave band.

In some demonstrative aspects, device 102 and/or device 140 may be configured to implement one or more MAC-based operations and/or functionalities, which may be configured to provide a technical solution to help simplify one or more operations at the mmWave band, or to make one or more operations at the mmWave band more efficient, e.g., as described below.

In some demonstrative aspects, device 102 and/or device 140 may be configured to implement a technical solution to support co-located sub-10 Ghz and mmWave functionalities, for example, utilizing multi-link operation, e.g., as described below.

In some demonstrative aspects, device 102 and/or device 140 may be configured to implement STAs/APs operative over the mmWave band, e.g., a 60 GHz band, for example, as part of an MLD, e.g., together with STAs/APs operating in the sub-10 Ghz band, for example, a sub-7 GHz band, e.g., including the 2.4/5/6 GHz bands.

In some demonstrative aspects, device 102 and/or device 140 may be configured to utilize communications over the sub-10 GHz band, for example, to assist in one or more operations and/or functionalities over the mmWave frequency band, e.g., as described below.

In some demonstrative aspects, device 102 and/or device 140 may be configured to utilize communications over the sub-10 GHz band, for example, to communicate mmWave information, which may be configured to support one or more operations and/or functionalities over the mmWave frequency band, e.g., as described below.

In some demonstrative aspects, device 102 and/or device 140 may be configured to utilize communications over the sub-10 GHz band, for example, to assist in discovery and/or association over the mmWave frequency band, e.g., as described below.

In other aspects, device 102 and/or device 140 may be configured to utilize communications over the sub-10 GHz band, for example, to assist in any other additional or alternative operations over the mmWave frequency band.

In some demonstrative aspects, for example, in some use cases, implementations, scenarios, and/or deployments, it may be disadvantageous to perform discovery and/or association procedures between two mmWave STAs solely over the mmWave band, e.g., the 60 GHz band. For example, when limiting the discovery and/or association procedures to be solely performed over the mmWave band, range may quickly become an issue, in a way which may require that the discovery procedure may need to rely on beamforming training, e.g., before being able to detect a peer to connect to.

In some demonstrative aspects, devices 102 and/or 140 may be configured to implement a sub-10 GHz assistance mechanism, which may be configured to assist a first mmWave STA, e.g., mmWave STA 161, to discover and/or associate with a second mmWave STA, e.g., mmWave STA 141, for example, based on the assistance of mmWave information communicated over the sub-GHz band, e.g., as described below.

In some demonstrative aspects, the assistance of mmWave information may be communicated from a sub-10 GHz AP, e.g., AP STA 135, AP STA 137 and/or AP STA 139, which may be co-located with the second mmWave STA, e.g., as described below.

In some demonstrative aspects, a sub-10 Ghz AP of an AP MLD, e.g., each sub-10 Ghz AP of the AP MLD, for example, AP 135, AP 137 and/or AP 139 of AP MLD 131, may be configured to transmit one or more frames to assist in discovery and/or association of an mmWave STA, e.g., the mmWave STA 141 of AP MLD 131, as described below.

In some demonstrative aspects, controller 124 may be configured to cause an AP MLD implemented by device 102, e.g., AP MLD 131, to transmit a first frame from a sub-10 GHz AP of the AP MLD over a sub-10 GHz wireless communication channel, e.g., as described below.

In some demonstrative aspects, the first frame may include a neighbor AP information field, e.g., as described below.

In some demonstrative aspects, the neighbor AP information field may include mmWave information corresponding to an mmWave STA of the AP MLD, e.g., as described below.

In some demonstrative aspects, the mmWave information corresponding to the mmWave STA may include channel information to indicate an mmWave wireless communication channel of the mmWave STA, e.g., as described below.

For example, controller 124 may be configured to cause AP MLD 131 to transmit the first frame from AP 135, AP 137, and/or AP 139 over the sub-10 GHz wireless communication channel.

For example, the first frame may include a neighbor AP information field including mmWave information corresponding to mmWave STA 141.

For example, the mmWave information corresponding to mmWave STA 141 may include channel information to indicate the mmWave wireless communication channel of mmWave STA 141.

In some demonstrative aspects, controller 124 may be configured to cause the AP MLD implemented by device 102, e.g., AP MLD 131, to communicate a second frame by the mmWave STA, e.g., mmWave STA 141, as described below.

In some demonstrative aspects, the second frame may be communicated by the mmWave STA, e.g., mmWave STA 141, with a non-AP MLD, e.g., MLD 151, over the mmWave wireless communication channel, e.g., as described below.

In some demonstrative aspects, the mmWave STA, e.g., mmWave STA 141, may include an mmWave AP or an mmWave network controller, to control communication over an mmWave wireless communication network, e.g., as described below.

In some demonstrative aspects, controller 124 may be configured to cause radio 114 to transmit the first frame over the sub-10 GHz wireless communication channel, and/or to communicate the second frame over the mmWave wireless communication channel, e.g., as described below.

In some demonstrative aspects, the mmWave wireless communication channel may include a channel bandwidth of 160 Megahertz (MHz), or an integer multiple of 160 Mhz, e.g., as described below.

In some demonstrative aspects, the mmWave wireless communication channel may include a 60 GHz channel, e.g., as described below.

In other demonstrative aspects, the mmWave wireless communication channel may include any other additional or alternative channel.

In some demonstrative aspects, the sub-10 GHz wireless communication channel may include a sub-7 GHz channel, e.g., as described below.

In some demonstrative aspects, the sub-10 GHz wireless communication channel may include a 2.4 GHz channel, a 5 GHz channel, and/or a 6 GHz channel.

In other demonstrative aspects, the sub-10 GHz wireless communication channel may include any other additional or alternative channel, e.g., with a starting frequency below 7 GHz or above 7 GHz.

In some demonstrative aspects, the first frame may include a beacon frame, e.g., as described below.

In some demonstrative aspects, the first frame may include a probe response frame, e.g., as described below.

In some demonstrative aspects, controller 124 may be configured to cause the AP MLD implemented by device 102, e.g., AP MLD 131, to transmit the probe response frame from a sub-10 GHz AP of the AP MLD, for example, in response to a probe request received from the non-AP MLD, e.g., MLD 151, over the sub-10 GHz wireless communication channel, e.g., as described below.

In some demonstrative aspects, the first frame may include a Multi-Link (ML) probe response frame, e.g., as described below.

In some demonstrative aspects, controller 124 may be configured to cause the AP MLD implemented by device 102, e.g., AP MLD 131, to transmit the ML probe response frame, for example, in response to a ML probe request received from the non-AP MLD, e.g., MLD 151, over the sub-10 GHz wireless communication channel, e.g., as described below.

In some demonstrative aspects, the ML probe response frame may include a plurality of mmWave beacon elements configured for a beacon of the mmWave STA, e.g., mmWave STA 141, over the mmWave wireless communication channel, e.g., as described below.

In other aspects, the first frame may include any other additional or alternative type of frame.

In some demonstrative aspects, the neighbor AP information field in the first frame may include a Target Beacon Transmission Time (TBTT) information field corresponding to the mmWave STA, e.g., mmWave STA 141, e.g., as described below.

In some demonstrative aspects, the TBTT information field corresponding to mmWave STA 141 may include the mmWave information corresponding to mmWave STA 141, e.g., as described below.

In some demonstrative aspects, the TBTT information field corresponding to mmWave STA 141 may include an mmWave parameters subfield including information of one or more parameters corresponding to mmWave STA 141, e.g., as described below.

In some demonstrative aspects, controller 124 may be configured to cause the AP MLD implemented by device 102 to include one or more mmWave beacon elements of the mmWave STA in beacon and/or probe response frames transmitted by the sub-10 GHz AP of the AP MLD, e.g., as described below.

For example, controller 124 may be configured to cause AP MLD 131 to include one or more mmWave beacon elements of mmWave STA 141 in beacon and/or probe response frames, e.g., some or all, beacon and/or probe response frames, transmitted by AP 135, AP 137, and/or AP 139.

In some demonstrative aspects, controller 124 may be configured to cause the AP MLD implemented by device 102 to include the mmWave information corresponding to the mmWave STA in all beacon and probe response frames transmitted by any sub-10 GHz AP of the AP MLD, e.g., as described below.

For example, controller 124 may be configured to cause AP MLD 131 to include the mmWave information corresponding to mmWave STA 141 in all beacon and probe response frames transmitted by any one of AP 135, AP 137, and/or AP 139.

In some demonstrative aspects, the neighbor AP information field may include a Time Synchronization Function (TSF) offset field configured to indicate a TSF offset between the mmWave STA and the sub-10 GHz AP, e.g., as described below.

For example, the neighbor AP information field may include a TSF offset field configured to indicate a TSF offset between mmWave STA 141 and AP 135, AP 137, and/or AP 139.

In some demonstrative aspects, controller 124 may be configured to cause the AP MLD implemented by device 102 to configure a same TSF for the mmWave STA and all sub-10 GHz APs of the AP MLD, e.g., as described below.

For example, controller 124 may be configured to cause AP MLD 131 to configure a same TSF for mmWave STA 141 and all of AP 135, AP 137, and AP 139.

In some demonstrative aspects, controller 124 may be configured to cause the mmWave STA implemented by device 102 to associate with the non-AP MLD, for example, based on an association request received by the sub-10 GHz AP from the non-AP MLD, e.g., as described below.

For example, controller 124 may be configured to cause mmWave STA 141 to associate with MLD 151, for example, based on an association request received from MLD 151, e.g., by AP 135, AP 137, and/or AP 139.

In some demonstrative aspects, controller 124 may be configured to cause the mmWave STA implemented by device 102, e.g., mmWave STA 141, to determine whether to accept the associate request, for example, based on signal strength information in the association request. For example, the signal strength information may indicate a received signal strength of a transmission from mmWave STA 141, e.g., as described below.

In some demonstrative aspects, controller 154 may be configured to cause a non-AP MLD implemented by device 140, e.g., MLD 151, to process a first frame from an AP MLD, e.g., AP MLD 131, the first frame received at a sub-10 GHz non-AP STA of the non-AP MLD over a sub-10 GHz wireless communication channel, e.g., as described below.

In some demonstrative aspects, the first frame may include a neighbor AP information field, e.g., as described below.

In some demonstrative aspects, the neighbor AP information field may include mmWave information corresponding to an mmWave STA of the AP MLD, e.g., as described below.

In some demonstrative aspects, the mmWave information corresponding to the mmWave STA of the AP MLD may include channel information to indicate an mmWave wireless communication channel of the mmWave STA of the AP MLD, e.g., as described below.

For example, controller 154 may be configured to cause MLD 151 to process at STA 155, STA 157, and/or STA 159 the first frame received from AP MLD 131 over the sub-10 GHz wireless communication channel.

For example, the first frame may include the neighbor AP information field including mmWave information corresponding to mmWave STA 141.

For example, the mmWave information corresponding to mmWave STA 141 may include channel information to indicate an mmWave wireless communication channel of mmWave STA 141.

In some demonstrative aspects, controller 154 may be configured to cause the non-AP MLD implemented by device 140, e.g., MLD 151, to associate an mmWave STA of the non-AP MLD with the mmWave STA of the AP MLD, for example, based on the mmWave information corresponding to the mmWave STA of the AP MLD, e.g., as described below.

For example, controller 154 may be configured to cause MLD 151 to associate mmWave STA 161 with mmWave STA 141, for example, based on the mmWave information corresponding to mmWave STA 141.

In some demonstrative aspects, controller 154 may be configured to cause the non-AP MLD implemented by device 140, e.g., MLD 151, to communicate a second frame between the mmWave STA of the non-AP MLD, e.g., mmWave STA 161, and the mmWave STA of the AP MLD, e.g., mmWave STA 141, over the mmWave wireless communication channel, e.g., as described below.

In some demonstrative aspects, controller 154 may be configured to cause radio 144 to receive the first frame over the sub-10 GHz wireless communication channel, and to communicate the second frame over the mmWave wireless communication channel, e.g., as described below.

In some demonstrative aspects, the first frame may include a beacon frame, e.g., as described below.

In some demonstrative aspects, the first frame may include a probe response frame, for example, in response to a probe request frame, e.g., as described below.

In some demonstrative aspects, controller 154 may be configured to cause the sub-10 GHz STA of the non-AP MLD, e.g., STA 155, STA 157, and/or STA 159, to transmit the probe request frame to the AP MLD, e.g., AP MLD 131, over the sub-10 GHz wireless communication channel, e.g., as described below.

In some demonstrative aspects, the first frame may include a ML probe response frame, for example, in response to a ML probe request frame, e.g., as described below.

In some demonstrative aspects, controller 154 may be configured to cause the sub-10 GHz STA of the non-AP MLD, e.g., STA 155, STA 157, and/or STA 159, to transmit the ML probe request frame to the AP MLD, e.g., AP MLD 131, over the sub-10 GHz wireless communication channel, e.g., as described below.

In some demonstrative aspects, the ML probe response frame may include a plurality of mmWave beacon elements configured for a beacon of the mmWave STA of the AP MLD, e.g., mmWave STA 141, e.g., as described below.

In other aspects, the first frame may include any other additional or alternative type of frame.

In some demonstrative aspects, the neighbor AP information field in the first frame may include a TBTT information field corresponding to the mmWave STA of the AP MLD, e.g., mmWave STA 141, e.g., as described below.

In some demonstrative aspects, the TBTT information field corresponding to mmWave STA 141 may include the mmWave information corresponding to mmWave STA 141, e.g., as described below.

In some demonstrative aspects, the TBTT information field corresponding to mmWave STA 141 may include an mmWave parameters subfield including information of one or more parameters corresponding to mmWave STA 141, e.g., as described below.

In some demonstrative aspects, controller 154 may be configured to cause the non-AP MLD implemented by device 140, e.g., MLD 151, to identify one or more mmWave beacon elements of the mmWave STA of the AP MLD in beacon and/or probe response frames from a sub-10 GHz AP of the AP MLD, e.g., as described below.

For example, controller 154 may be configured to cause MLD 151 to identify one or more mmWave beacon elements of mmWave STA 141 in beacon and/or probe response frames, e.g., some or all, beacon and/or probe response frames, transmitted by AP 135, AP 137, and/or AP 139.

In some demonstrative aspects, the neighbor AP information field may include a TSF offset field configured to indicate a TSF offset between the mmWave STA of the AP MLD and a sub-10 GHz AP of the AP MLD, e.g., as described below.

For example, the neighbor AP information field may include a TSF offset field configured to indicate a TSF offset between mmWave STA 141 and AP 135, AP 137, and/or AP 139.

In some demonstrative aspects, controller 154 may be configured to cause the non-AP MLD implemented by device 140, e.g., MLD 151, to determine a same TSF for the mmWave STA of the AP MLD and a sub-10 GHz AP of the AP MLD, e.g., as described below.

For example, controller 154 may be configured to cause MLD 151 to determine a same TSF for mmWave STA 141 and AP 135, AP 137, and/or AP 139.

In some demonstrative aspects, controller 154 may be configured to cause the mmWave STA of the non-AP MLD implemented by device 140, e.g., mmWave STA 161, to transmit an association request to the AP MLD, e.g., AP MLD 131, for example, based on the mmWave information corresponding to the mmWave STA of the AP MLD, e.g., mmWave STA 141, e.g., as described below.

In some demonstrative aspects, the association request may include signal strength information indicating a received signal strength determined by the mmWave STA of the non-AP MLD, e.g., mmWave STA 161, for example, based on a transmission from the mmWave STA of the AP MLD, e.g., mmWave STA 141, e.g., as described below.

In some demonstrative aspects, controller 124 may be configured to cause the AP MLD implemented by device 102, e.g., AP MLD 131, to perform one or more operations of an AP MLD according to mmWave assistance mechanism, e.g., by implementing one or more of, e.g., some or all of, the definitions and/or operations described below.

In some demonstrative aspects, controller 154 may be configured to cause the MLD implemented by device 140, e.g., MLD 151, to perform one or more operations of an MLD according to mmWave assistance mechanism, e.g., by implementing one or more of, e.g., some or all of, the definitions and/or operations described below.

In some demonstrative aspects, a mmWave STA, e.g., mmWave STA 141, may perform one or more operations, one or more functionalities, the role of, and/or the functionality of, an mmWave AP, e.g., a 60 GHz AP, which may be a part of an AP MLD, e.g., AP MLD 131, with at least one other AP operating in a sub-10 Ghz band, e.g., a sub-7 GHz band, for example, AP 135, AP 137, and/or AP 139.

In other demonstrative aspects, the mmWave STA, e.g., mmWave STA 141, may perform one or more operations, one or more functionalities, the role of, and/or the functionality of, any other mmWave STA, e.g., an mmWave network controller. For example, different terminology, e.g., other than “AP STA” may be implemented to refer to a network controller functionality of a STA over the mmWave band, e.g., the 60 Ghz band.

In some demonstrative aspects, a mmWave STA, e.g., mmWave STA 161, may perform one or more operations, one or more functionalities, the role of, and/or the functionality of, an mmWave STA, e.g., a 60 GHz STA, which may be a part of a non-AP MLD, e.g., MLD 151, with at least one other non-AP STA operating in a sub-10 Ghz band, e.g., a sub-7 GHz band, for example, STA 155, STA 157, and/or STA 159.

In some demonstrative aspects, one or more rules for AP discovery may be redefined, modified and/or adjusted, for example, in comparison to a current version of an IEEE 802.11be Specification, e.g., as described below.

In some demonstrative aspects, device 102 and/or device 140 may be configured to utilize one or more rules for AP discovery according to the mmWave assistance mechanism, e.g., as follows:

In some use cases, implementations, scenarios, and/or deployments, it may be defined that all APs operating in the sub-10 Ghz band, e.g., the sub-7 GHz band, which are co-located in a same AP MLD with an mmWave STA, e.g., a 60 GHz AP, may, e.g., shall, include in the Beacon and Probe Response frames they send a TBTT Information field, for example, in a Reduced Neighbor Report element, for example, with the Neighbor AP TBTT Offset subfield, the BSSID subfield, the Short-SSID subfield, the BSS Parameters subfield, and/or the MLD Parameters subfield. For example, this information may be included for each of the other APs affiliated to the same AP MLD, including the mmWave STA, e.g., the 60 GHz AP.
The TBTT information field may be included in the neighbor AP information field, which may indicate in the Operating Class and the Channel Number fields the operating class and channel number corresponding to the operation at the mmWave band, e.g., the 60 GHz band. It may be more efficient to define a new channelization at 60 GHz with operating class and channel numbers corresponding to the new PHY design. The indicated channel number may correspond to a primary channel at 60 GHz, and the primary channel may include a channel bandwidth of 160 MHz or 320 MHz, or any other integer multiple of 160 MHz.
The TBTT Information field may include a 60 GHz Parameters subfield, for example, to allow to add some extra information in the RNR.
   For example, if an initial training sequence is scheduled in a periodic manner, some extra information may be indicated in the 60 GHz Parameters subfield, e.g., timing and parameters information, and/or any other additional or alternative information.
   For example, extra information, e.g., timing and parameters information, may also be contained in a Basic variant Multi-link element.
In some use cases, implementations, scenarios, and/or deployments, all APs operating in the sub-10 GHz band, e.g., the sub-7 GHz band, in the same AP MLD as the mmWave STA, e.g., the 60 GHz AP, may, e.g., shall, include a Basic variant Multi-link element in the Beacon and Probe Response frames they send. The Basic variant Multi-link element may include, for example, common information regarding the AP MLD, and a per-STA profile, for example, when there is some specific information that needs to be carried for the mmWave STA, e.g., the 60 GHz AP. For example, the specific information for the for the mmWave STA may include a critical update, TWT schedules, and/or any other additional or alternative information.
The mmWave STA, e.g., the 60 GHz AP may not have to, or may be allowed to select not to, transmit Beacon frames at TBTT, e.g., for all associated STAs. For example, this may allow avoiding an overhead, which may result from sending the Beacon frame multiple times, for example, by using a sector sweep in order to enable all STAs to receive at least one of the Beacon frames at TBTT
   For example, short beacon frames, e.g., a new management frame, may include only update information and/or real time operation parameters, e.g., TIM, Broadcast TWT, and/or any other additional or alternative information. For example, the short beacon frames may be transmitted in unicast manner to each associated STA at 60 GHz, and may be scheduled through individual TWT.
   For example, beacon frames in the lower band, e.g., the sub-10 GHz band, may also include the relevant information, e.g., TIM or multi-link TIM that applies also or specifically to the 60 GHz band, and an indication whether a critical update happened. For example, it may be when there are TWT schedules at the mmWave band. e.g., the 60 GHz band, these TWT schedules may also be advertised by the sub-7 GHz APs. For example, the TWT schedules may be included in the per-STA profile of the Multi-link element corresponding to the 60 GHz AP. This may enable a non-AP MLD to use only the lower band to monitor activities, and to operate at the mmWave band. e.g., the 60 GHz band, for example, only when needed, e.g., to detect when an AP has something to transmit to the non-AP STA, to detect whether there is a change in its schedule, and/or to detect whether there is a need for beamforming (re)training.
   In some use cases, implementations, scenarios, and/or deployments, it may be decided that transmitting beacons is completely forbidden by the mmWave STA of the AP MLD. Alternatively, it may be decided that transmitting beacons by the mmWave STA of the AP MLD is not mandated.

In some demonstrative aspects, the presence of a Reduced Neighbor Report (RNR) and/or a Multi-Link element, e.g., in accordance with the IEEE 802.11be Specification, in the beacon and probe response frames transmitted by sub-7 GHz APs belonging to the same AP MLD as the 60 GHz AP may allow non-AP STA to perform scanning of the lower bands, for example, to do a basic discovery of the 60 GHz AP, for example, even without having to scan the 60 GHz band.

In some demonstrative aspects, sub-7 GHz APs may be configured to transmit the TSF Offset over the sub-7 GHz wireless communication channel, for example, when there is no 60 GHz Beacon, and the TSF of 60 GHz AP is not the same as TSF of the sub-7 GHz APs belonging to the same AP MLD as the 60 GHz AP.

In some demonstrative aspects, the TSF Offset subfield may include a TSF timer offset of the 60 GHz AP, e.g., as described above.

For example, the TSF timer offset may indicate a time difference, e.g., in Time Units (TUs), between the sub-7 GHz AP that transmits the TSF Offset and the 60 GHz AP.

In some demonstrative aspects, the TSF timer offset may be calculated as a modulo of the transmitted Beacon Interval of the sub-7 GHz AP, which may be rounded to the nearest TU boundary. For example, when no beacon is transmitted over the 60 GHz wireless communication channel, then there is no beacon interval in the 60 GHz wireless communication channel.

In other demonstrative aspects, the TSF timer may be calculated using any other additional or alternative mechanism.

In some demonstrative aspects, an AP MLD may be configured to configure the same TSF for the 60 GHz AP and all sub-7 GHz APs that are affiliated with the same AP MLD as the 60 GHz AP.

In some demonstrative aspects, in order to perform a complete discovery of the 60 GHz AP of the AP MLD, STAs of the non-AP MLD may send an ML probe request to the sub-7 GHz AP of the AP MLD and, in response to the ML probe request, the sub-7 GHz AP may send an ML probe response with an ML element carrying the complete information for the 60 GHz AP of the AP MLD.

In some demonstrative aspects, the ML probe response may contain all the elements/fields that would be included in a beacon frame and/or a probe response frame transmitted by the 60 GHz AP of the AP MLD. Accordingly, the 60 GHz STA of the non-AP MLD may have all the needed information before association. The providing of the information of the 60 GHz AP in frames sent by the sub-7 GHz APs may result in the non-AP STA missing information corresponding to whether the 60 GHz AP of the AP MLD is in range, and/or whether the non-AP STA of the non-AP MLD that is operating on the 60 Ghz band may be allowed to close the link with the 60 GHz AP.

In some demonstrative aspects, the Beacon interval may be reserved, for example, when no Beacon frame is transmitted over the 60 GHz wireless communication channel.

In some demonstrative aspects, in order to accelerate the discovery operation, it may be advantageous to mandate or allow that the sub-7 GHz AP of the AP MLD should always include complete information of the 60 GHz AP of the AP MLD in the beacon frames and the probe response frames transmitted by the sub-7 GHz APs of the AP MLD. However, such a requirement may come at the cost of increased overhead. In other aspects, real time operational parameters, e.g., TWT, TIM, and/or any other additional or alternative parameters, may always be present in the beacon frame, e.g., as described above.

In some demonstrative aspects, once all the discovery information is obtained at the non-AP MLD, association can be done with the AP MLD and, specifically, with the 60 GHz AP of the AP MLD, for example, through a Multi-Link setup procedure, for example, in accordance with the IEEE 802.11be Specification.

For example, in order to perform the ML setup, an Association Request frame, which may include, for example, a Multi-link element with a per-STA profile for each link that is requested, may be sent by the non-AP MLD on any link. In one example, the Association Request frame may be sent from a non-AP STA of the non-AP MLD to the sub-7 GHz APs of the AP MLD. For example, the Association Request frame may be configured to request association of the non-AP MLD to the AP MLD. For example, the Association Request frame may include the link of the 60 GHz AP, e.g., in accordance with an IEEE 802.11be procedure.

In some demonstrative aspects, the non-AP MLD may not receive from the sub-7 GHz AP of the AP MLD information regarding whether the non-AP MLD is at range of the 60 GHz AP of the AP MLD.

In some demonstrative aspects, it may be advantageous for the non-AP MLD and the AP MLD to have confidence that they can close the link and reach each other over the 60 GHz wireless communication channel, for example, before allowing association over the 60 GHz wireless communication channel.

In some demonstrative aspects, it may be advantageous to employ a mechanism allowing to complete the complete discovery procedure, for example, by allowing a rough Received Signal Strength Indication (RSSI) estimation at the 60 GHz, e.g., of a signal from the sub-7 GHz AP of the AP MLD.

For example, it may be advantageous to perform a simple beamforming training, for example, to beamform an AP signal on which the STA is to perform the RSSI measurement. For example, this beamforming training may provide a technical solution to better match a range at which the STA would be able to operate at 60 GHz with the AP.

In some demonstrative aspects, it may be advantageous to perform the beamforming training with a very short beamforming frame and/or with a Null-Data-Packet (NDP) frame, for example, instead of beacon frames.

In some demonstrative aspects, the beamforming training may be scheduled periodically for any STA, for example, during every TBTT, or at any other periodicity. For example, this schedule of the beamforming training may be advertised in the beacons and/or probe response frames transmitted by the sub-7 GHz APs of the AP MLD, for example, with a dedicated broadcast of TWT in a per-STA profile in an ML element, or any other field or element.

In other demonstrative aspects, the beamforming training may be scheduled specifically for a particular STA of the non-AP MLD, for example through a request. For example, the ML probe request from the non-AP MLD may ask for a basic beamforming training phase to be scheduled, and the exact schedule for the beamforming training phase can be advertised by the AP MLD, e.g., in the ML probe response. In one example, a dedicated negotiation may be performed, for example, to determine the time at which the beamforming training will be scheduled, for example, with a modified individual TWT negotiation.

In some demonstrative aspects, the non-AP MLD may include information, e.g., the RSSI measurement that was made during the beamforming training phase, and/or the sector ID of the best sector that was detected, in the association request, e.g., which requests the ML association including a 60 GHz AP of the AP MLD. In one example, it may be mandated that the non-AP MLD include this information in the association request, for example, in order to make sure that the non-AP MLD went through the beamforming training procedure. In another example, the sub-7 GHz AP of the AP MLD may use the results of the beamforming training procedure, for example, to determine whether or not the 60 GHz link should be accepted in the ML setup.

In some demonstrative aspects, the STA of the non-AP MLD may be configured to report to the AP MLD in the sub-7 GHz band that the STA is not in range of the 60 GHz STA of the AP MLD, for example, when the STA of the non-AP MLD was not able to detect any of the signals sent over 60 GHz wireless communication channel by the 60 GHz AP of the AP MLD during the beamforming training.

In some demonstrative aspects, when the beamforming training procedure is done through the association process, the STA of the non-AP MLD may decide not to accept the 60 GHz link in the ML setup, and may later add the 60 GHz link to the ML setup for the non-AP MLD, for example, by using an add/remove link procedure when the non-AP STA of the non-AP MLD becomes in range of the 60 GHz AP of the AP MLD. For example, even when the STA of the non-AP MLD is not in range of the AP at 60 GHz wireless communication channel, the ML setup can still be accepted including the 60 GHz link. In this case, for example, the 60 GHz link may be set up and not used until the STA of the non-AP MLD is in range, or can be set up but disabled, e.g., until the STA of the non-AP MLD is in range, at which time the link may be enabled.

In some demonstrative aspects, when the beamforming training procedure is done after association, the 60 GHz link may be removed from the ML setup or may be disabled, for example, when the STA of the non-AP MLD is not in range. For example, the 60 GHz link may stay associated and enabled but would not be used until the STA of the non-AP MLD is in range again.

In some demonstrative aspects, for example, during post-association operation, update information, which is typically carried in a beacon, may be unicasted to the STA of the non-AP MLD, or retrieved in the sub-7 GHz band, for example, by being always advertised in the beacon of sub-7 GHz APs in the same AP MLD as the 60 GHz AP.

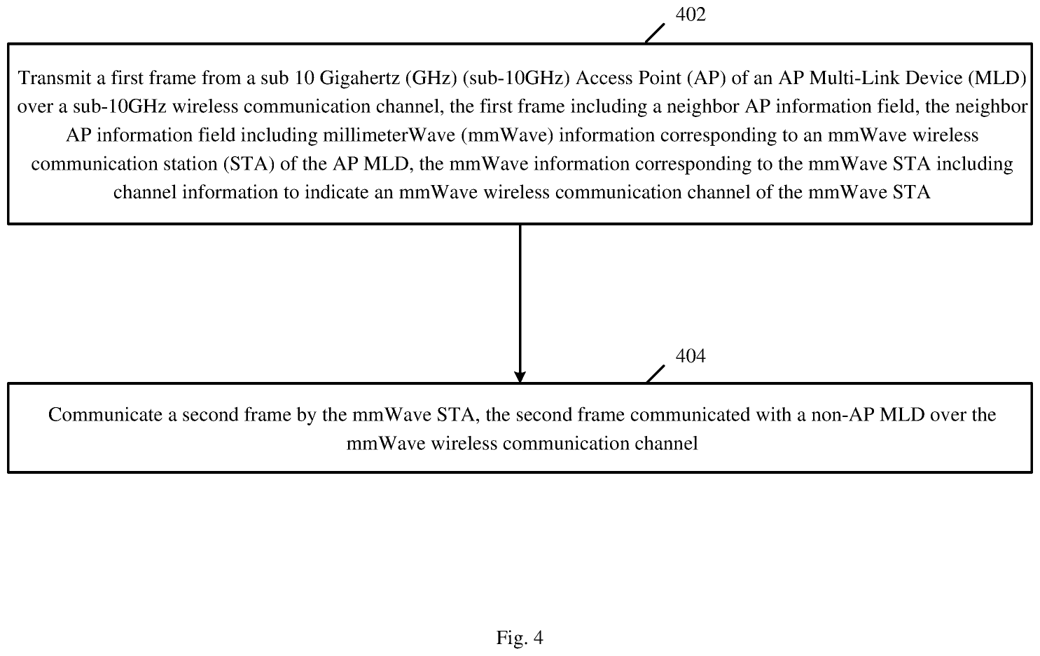

Reference is made to FIG. 4, which schematically illustrates a method of communicating over an mmWave wireless communication channel based on mmWave information communicated over a sub-10 GHz wireless communication channel. For example, one or more of the operations of the method of FIG. 4 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include transmitting a first frame from a sub-10 GHz AP of an AP MLD over a sub-10 GHz wireless communication channel, the first frame including a neighbor AP information field, the neighbor AP information field including mmWave information corresponding to an mmWave STA of the AP MLD, the mmWave information corresponding to the mmWave STA including channel information to indicate an mmWave wireless communication channel of the mmWave STA. For example, controller 124 (FIG. 1) may be configured to cause, trigger, and/or control AP MLD 131 (FIG. 1) to transmit the first frame from AP 135 (FIG. 1), AP 137 (FIG. 1), and/or AP 139 (FIG. 1) over the sub-10 GHz wireless communication channel, e.g., as described above.

As indicated at block 404, the method may include communicating a second frame by the mmWave STA, the second frame communicated with a non-AP MLD over the mmWave wireless communication channel. For example, controller 124 (FIG. 1) may be configured to cause, trigger, and/or control AP MLD 131 (FIG. 1) to communicate the second frame by mmWave STA 141 (FIG. 1) with non-AP MLD 151 (FIG. 1) over the mmWave wireless communication channel, e.g., as described above.

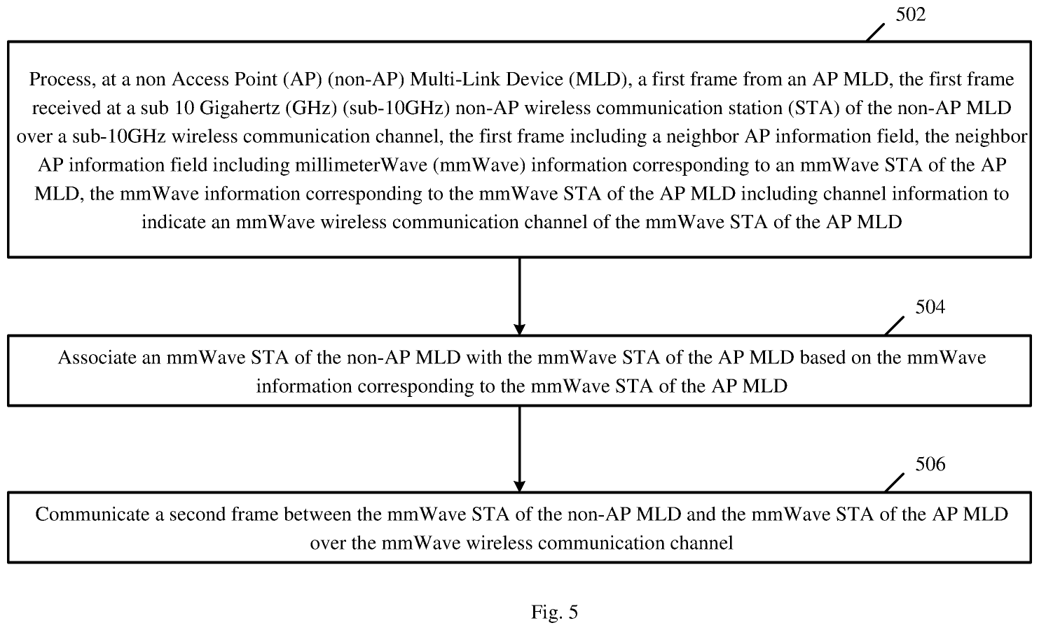

Reference is made to FIG. 5, which schematically illustrates a method of communicating over an mmWave wireless communication channel based on mmWave information communicated over a sub-10 GHz wireless communication channel. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing, at a non-AP MLD, a first frame from an AP MLD, the first frame received at a sub-10 GHz non-AP STA of the non-AP MLD over a sub-10 GHz wireless communication channel, the first frame including a neighbor AP information field, the neighbor AP information field including mmWave information corresponding to an mmWave STA of the AP MLD, the mmWave information corresponding to the mmWave STA of the AP MLD including channel information to indicate an mmWave wireless communication channel of the mmWave STA of the AP MLD. For example, controller 154 (FIG. 1) may be configured to cause, trigger, and/or control non-AP MLD 151 (FIG. 1) to process the first frame from AP MLD 131 (FIG. 1), the first frame received at STA 155 (FIG. 1), STA 157 (FIG. 1), and/or STA 159 (FIG. 1) over the sub-10 GHz wireless communication channel, e.g., as described above.

As indicated at block 504, the method may include associating an mmWave STA of the non-AP MLD with the mmWave STA of the AP MLD, for example, based on the mmWave information corresponding to the mmWave STA of the AP MLD. For example, controller 154 (FIG. 1) may be configured to cause, trigger, and/or control non-AP MLD 151 (FIG. 1) to associate mmWave STA 161 (FIG. 1) with mmWave STA 141 (FIG. 1), for example, based on the mmWave information corresponding to mmWave STA 141 (FIG. 1), e.g., as described above.

As indicated at block 506, the method may include communicating a second frame between the mmWave STA of the non-AP MLD and the mmWave STA of the AP MLD over the mmWave wireless communication channel. For example, controller 154 (FIG. 1) may be configured to cause, trigger, and/or control non-AP MLD 151 (FIG. 1) to communicate the second frame between mmWave STA 161 (FIG. 1) and mmWave STA 141 (FIG. 1) over the mmWave wireless communication channel, e.g., as described above.

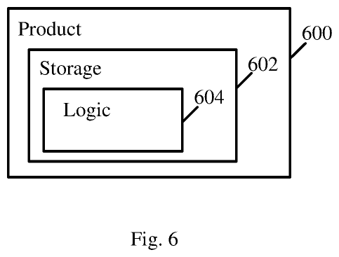

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further aspects.

Example 1 includes an apparatus comprising logic and circuitry configured to cause an Access Point (AP) Multi-Link Device (MLD) to transmit a first frame from a sub 10 Gigahertz (GHz) (sub-10 GHz) AP of the AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA comprising channel information to indicate an mmWave wireless communication channel of the mmWave STA; and communicate a second frame by the mmWave STA, the second frame communicated with a non-AP MLD over the mmWave wireless communication channel.

Example 2 includes the subject matter of Example 1, and optionally, wherein the neighbor AP information field comprises a Target Beacon Transmission Time (TBTT) information field corresponding to the mmWave STA, the TBTT information field corresponding to the mmWave STA comprising the mmWave information corresponding to the mmWave STA.

Example 3 includes the subject matter of Example 2, and optionally, wherein the TBTT information field corresponding to the mmWave STA comprises an mmWave parameters subfield comprising information of one or more parameters corresponding to the mmWave STA.

Example 4 includes the subject matter of any one of Examples 1-3, and optionally, wherein the apparatus is configured to cause the AP MLD to include one or more mmWave beacon elements of the mmWave STA in beacon and probe response frames transmitted by the sub-10 GHz AP of the AP MLD.

Example 5 includes the subject matter of any one of Examples 1-4, and optionally, wherein the apparatus is configured to cause the AP MLD to include the mmWave information corresponding to the mmWave STA in all beacon and probe response frames transmitted by any sub-10 GHz AP of the AP MLD.

Example 6 includes the subject matter of any one of Examples 1-5, and optionally, wherein the neighbor AP information field comprises a Time Synchronization Function (TSF) offset field configured to indicate a TSF offset between the mmWave STA and the sub-10 GHz AP.

Example 7 includes the subject matter of any one of Examples 1-6, and optionally, wherein the apparatus is configured to cause the AP MLD to configure a same Time Synchronization Function (TSF) for the mmWave STA and all sub-10 GHz APs of the AP MLD.

Example 8 includes the subject matter of any one of Examples 1-7, and optionally, wherein the first frame comprises a probe response frame, the probe response frame in response to a probe request received from the non-AP MLD over the sub-10 GHz wireless communication channel.

Example 9 includes the subject matter of any one of Examples 1-8, and optionally, wherein the first frame comprises a Multi-Link (ML) probe response frame, the ML probe response frame in response to a ML probe request received from the non-AP MLD over the sub-10 GHz wireless communication channel.

Example 10 includes the subject matter of Example 9, and optionally, wherein the ML probe response frame comprises a plurality of mmWave beacon elements configured for a beacon of the mmWave STA over the mmWave wireless communication channel.

Example 11 includes the subject matter of any one of Examples 1-7, and optionally, wherein the first frame comprises a beacon frame.

Example 12 includes the subject matter of any one of Examples 1-11, and optionally, wherein the apparatus is configured to cause the mmWave STA to associate with the non-AP MLD based on an association request received by the sub-10 GHz AP from the non-AP MLD.

Example 13 includes the subject matter of Example 12, and optionally, wherein the apparatus is configured to cause the mmWave STA to determine whether to accept the associate request based on signal strength information in the association request, the signal strength information indicating a received signal strength of a transmission from the mmWave STA.

Example 14 includes the subject matter of any one of Examples 1-13, and optionally, wherein the mmWave wireless communication channel comprises a channel bandwidth of 160 Megahertz (MHz), or an integer multiple of 160 Mhz.

Example 15 includes the subject matter of any one of Examples 1-14, and optionally, wherein the mmWave STA comprises an mmWave AP or an mmWave network controller to control communication over an mmWave wireless communication network.

Example 16 includes the subject matter of any one of Examples 1-15, and optionally, wherein the sub-10 GHz wireless communication channel comprises a sub-7 GHz channel.

Example 17 includes the subject matter of any one of Examples 1-16, and optionally, wherein the mmWave wireless communication channel comprises a 60 GHz channel.

Example 18 includes the subject matter of any one of Examples 1-17, and optionally, comprising at least one radio to transmit the first frame over the sub-10 GHz wireless communication channel, and to communicate the second frame over the mmWave wireless communication channel.

Example 19 includes the subject matter of Example 18, and optionally, comprising one or more antennas connected to the radio, and a processor to execute instructions of an operating system of the AP MLD.

Example 20 includes an apparatus comprising logic and circuitry configured to cause a non Access Point (AP) (non-AP) Multi-Link Device (MLD) to process a first frame from an AP MLD, the first frame received at a sub 10 Gigahertz (GHz) (sub-10 GHz) non-AP STA of the non-AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA of the AP MLD comprising channel information to indicate an mmWave wireless communication channel of the mmWave STA of the AP MLD; based on the mmWave information corresponding to the mmWave STA of the AP MLD, associate an mmWave STA of the non-AP MLD with the mmWave STA of the AP MLD; and communicate a second frame between the mmWave STA of the non-AP MLD and the mmWave STA of the AP MLD over the mmWave wireless communication channel.

Example 21 includes the subject matter of Example 20, and optionally, wherein the neighbor AP information field comprises a Target Beacon Transmission Time (TBTT) information field corresponding to the mmWave STA of the AP MLD, the TBTT information field corresponding to the mmWave STA of the AP MLD comprising the mmWave information corresponding to the mmWave STA of the AP MLD.

Example 22 includes the subject matter of Example 21, and optionally, wherein the TBTT information field corresponding to the mmWave STA of the AP MLD comprises an mmWave parameters subfield comprising information of one or more parameters corresponding to the mmWave STA of the AP MLD.

Example 23 includes the subject matter of any one of Examples 20-22, and optionally, wherein the apparatus is configured to cause the non-AP MLD to identify one or more mmWave beacon elements of the mmWave STA of the AP MLD in at least one of a beacon frame or a probe response frame from a sub-10 GHz AP of the AP MLD.

Example 24 includes the subject matter of any one of Examples 20-23, and optionally, wherein the neighbor AP information field comprises a Time Synchronization Function (TSF) offset field configured to indicate a TSF offset between the mmWave STA of the AP MLD and a sub-10 GHz AP of the AP MLD.

Example 25 includes the subject matter of any one of Examples 20-24, and optionally, wherein the apparatus is configured to cause the non-AP MLD to determine a same Time Synchronization Function (TSF) for the mmWave STA of the AP MLD and a sub-10 GHz AP of the AP MLD.

Example 26 includes the subject matter of any one of Examples 20-25, and optionally, wherein the apparatus is configured to cause the sub-10 GHz STA of the non-AP MLD to transmit a probe request frame to the AP MLD over the sub-10 GHz wireless communication channel, wherein the first frame comprises a probe response frame in response to the probe request frame.

Example 27 includes the subject matter of any one of Examples 20-26, and optionally, wherein the apparatus is configured to cause the sub-10 GHz STA of the non-AP MLD to transmit a Multi-Link (ML) probe request frame to the AP MLD over the sub-10 GHz wireless communication channel, wherein the first frame comprises a ML probe response frame in response to the ML probe request frame.

Example 28 includes the subject matter of Example 27, and optionally, wherein the ML probe response frame comprises a plurality of mmWave beacon elements configured for a beacon of the mmWave STA of the AP MLD.

Example 29 includes the subject matter of any one of Examples 20-25, and optionally, wherein the first frame comprises a beacon frame.

Example 30 includes the subject matter of any one of Examples 20-29, and optionally, wherein the apparatus is configured to cause the mmWave STA of the non-AP MLD to transmit an association request to the AP MLD based on the mmWave information corresponding to the mmWave STA of the AP MLD.

Example 31 includes the subject matter of Example 30, and optionally, wherein the association request comprises signal strength information indicating a received signal strength determined by the mmWave STA of the non-AP MLD based on a transmission from the mmWave STA of the AP MLD.

Example 32 includes the subject matter of any one of Examples 20-31, and optionally, wherein the mmWave wireless communication channel comprises a channel bandwidth of 160 Megahertz (MHz), or an integer multiple of 160 Mhz.

Example 33 includes the subject matter of any one of Examples 20-32, and optionally, wherein the sub-10 GHz wireless communication channel comprises a sub-7 GHz channel.

Example 34 includes the subject matter of any one of Examples 20-33, and optionally, wherein the mmWave wireless communication channel comprises a 60 GHz channel.

Example 35 includes the subject matter of any one of Examples 20-34, and optionally, comprising at least one radio to receive the first frame over the sub-10 GHz wireless communication channel, and to communicate the second frame over the mmWave wireless communication channel.

Example 36 includes the subject matter of Example 35, and optionally, comprising one or more antennas connected to the radio, and a processor to execute instructions of an operating system of the non-AP MLD.

Example 37 comprises an apparatus comprising means for executing any of the described operations of Examples 1-36.

Example 38 comprises a product comprising one or more tangible computer-readable non-transitory storage media comprising computer-executable instructions operable to, when executed by at least one processor, enable the at least one processor to cause a computing device to perform any of the described operations of Examples 1-36.

Example 38 comprises an apparatus comprising: a memory interface; and processing circuitry configured to: perform any of the described operations of Examples 1-36.

Example 39 comprises a method comprising any of the described operations of Examples 1-36.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) Multi-Link Device (MLD) to:
transmit a first frame from a sub 10 Gigahertz (GHz) (sub-10 GHz) AP of the AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA comprising channel information to indicate an mmWave wireless communication channel of the mmWave STA; and
communicate a second frame by the mmWave STA, the second frame communicated with a non-AP MLD over the mmWave wireless communication channel.

2. The apparatus of claim 1, wherein the neighbor AP information field comprises a Target Beacon Transmission Time (TBTT) information field corresponding to the mmWave STA, the TBTT information field corresponding to the mmWave STA comprising the mmWave information corresponding to the mmWave STA.

3. The apparatus of claim 2, wherein the TBTT information field corresponding to the mmWave STA comprises an mmWave parameters subfield comprising information of one or more parameters corresponding to the mmWave STA.

4. The apparatus of claim 1 configured to cause the AP MLD to include one or more mmWave beacon elements of the mmWave STA in beacon and probe response frames transmitted by the sub-10 GHz AP of the AP MLD.

5. The apparatus of claim 1, wherein the neighbor AP information field comprises a Time Synchronization Function (TSF) offset field configured to indicate a TSF offset between the mmWave STA and the sub-10 GHz AP.

6. The apparatus of claim 1 configured to cause the AP MLD to configure a same Time Synchronization Function (TSF) for the mmWave STA and all sub-10 GHz APs of the AP MLD.

7. The apparatus of claim 1, wherein the first frame comprises a probe response frame, the probe response frame in response to a probe request received from the non-AP MLD over the sub-10 GHz wireless communication channel.

8. The apparatus of claim 1, wherein the first frame comprises a Multi-Link (ML) probe response frame, the ML probe response frame in response to a ML probe request received from the non-AP MLD over the sub-10 GHz wireless communication channel.

9. The apparatus of claim 1, wherein the first frame comprises a beacon frame.

10. The apparatus of claim 1 configured to cause the mmWave STA to associate with the non-AP MLD based on an association request received by the sub-10 GHz AP from the non-AP MLD.

11. The apparatus of claim 10 configured to cause the mmWave STA to determine whether to accept the associate request based on signal strength information in the association request, the signal strength information indicating a received signal strength of a transmission from the mmWave STA.

12. The apparatus of claim 1, wherein the mmWave wireless communication channel comprises a channel bandwidth of 160 Megahertz (MHz), or an integer multiple of 160 Mhz.

13. The apparatus of claim 1, wherein the mmWave STA comprises an mmWave AP or an mmWave network controller to control communication over an mmWave wireless communication network.

14. The apparatus of claim 1, wherein the sub-10 GHz wireless communication channel comprises a sub-7 GHz channel.

15. The apparatus of claim 1, wherein the mmWave wireless communication channel comprises a 60 GHz channel.

16. The apparatus of claim 1 comprising at least one radio to transmit the first frame over the sub-10 GHz wireless communication channel, and to communicate the second frame over the mmWave wireless communication channel.

17. The apparatus of claim 16 comprising one or more antennas connected to the radio, and a processor to execute instructions of an operating system of the AP MLD.

18. A product comprising one or more tangible computer-readable non-transitory storage media comprising computer-executable instructions operable to, when executed by at least one processor, enable the at least one processor to cause an Access Point (AP) Multi-Link Device (MLD) to:
transmit a first frame from a sub 10 Gigahertz (GHz) (sub-10 GHz) AP of the AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA comprising channel information to indicate an mmWave wireless communication channel of the mmWave STA; and
communicate a second frame by the mmWave STA, the second frame communicated with a non-AP MLD over the mmWave wireless communication channel.

19. The product of claim 18, wherein the instructions, when executed, cause the AP MLD to include one or more mmWave beacon elements of the mmWave STA in beacon and probe response frames transmitted by the sub-10 GHz AP of the AP MLD.

20. An apparatus comprising logic and circuitry configured to cause a non Access Point (AP) (non-AP) Multi-Link Device (MLD) to:
process a first frame from an AP MLD, the first frame received at a sub 10 Gigahertz (GHz) (sub-10 GHz) non-AP STA of the non-AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA of the AP MLD comprising channel information to indicate an mmWave wireless communication channel of the mmWave STA of the AP MLD;
based on the mmWave information corresponding to the mmWave STA of the AP MLD, associate an mmWave STA of the non-AP MLD with the mmWave STA of the AP MLD; and
communicate a second frame between the mmWave STA of the non-AP MLD and the mmWave STA of the AP MLD over the mmWave wireless communication channel.

21. The apparatus of claim 20 configured to cause the mmWave STA of the non-AP MLD to transmit an association request to the AP MLD based on the mmWave information corresponding to the mmWave STA of the AP MLD.

22. The apparatus of claim 21, wherein the association request comprises signal strength information indicating a received signal strength determined by the mmWave STA of the non-AP MLD based on a transmission from the mmWave STA of the AP MLD.

23. The apparatus of claim 20 comprising at least one radio to receive the first frame over the sub-10 GHz wireless communication channel, and to communicate the second frame over the mmWave wireless communication channel.

24. An apparatus comprising:
means for processing, at a non Access Point (AP) (non-AP) Multi-Link Device (MLD), a first frame from an AP MLD, the first frame received at a sub 10 Gigahertz (GHz) (sub-10 GHz) non-AP STA of the non-AP MLD over a sub-10 GHz wireless communication channel, the first frame comprising a neighbor AP information field, the neighbor AP information field comprising millimeterWave (mmWave) information corresponding to an mmWave wireless communication station (STA) of the AP MLD, the mmWave information corresponding to the mmWave STA of the AP MLD comprising channel information to indicate an mmWave wireless communication channel of the mmWave STA of the AP MLD;
means for causing the causing the non-AP MLD to associate an mmWave STA of the non-AP MLD with the mmWave STA of the AP MLD, based on the mmWave information corresponding to the mmWave STA of the AP MLD; and
means for causing the non-AP MLD to communicate a second frame between the mmWave STA of the non-AP MLD and the mmWave STA of the AP MLD over the mmWave wireless communication channel.

25. The apparatus of claim 24 comprising means for causing the mmWave STA of the non-AP MLD to transmit an association request to the AP MLD based on the mmWave information corresponding to the mmWave STA of the AP MLD.
